(19) United States
(12) Patent Application Publication
(10) Pub. No.: US 2009/0191438 A1
(43) Pub. Date: Jul. 30, 2009

(54) FUEL CELL SYSTEM

(76) Inventors: Nobuo Fujita, Aichi (JP); Masahiro Okuyoshi, Aichi (JP); Masataka Ota, Aichi (JP)

Correspondence Address: KENYON & KENYON LLP, 1500 K STREET N.W., SUITE 700, WASHINGTON, DC, 20005, US

(21) Appl. No.: 12/301,284

(22) PCT Filed: Apr. 19, 2007
(86) PCT No.: PCT/JP2007/058999

§ 371 Date: Nov. 18, 2008

(30) Foreign Application Priority Data
May 23, 2006 (JP) 2006-142783

(51) Int. Cl. H01M 8/04

(52) U.S. Cl. 429/24

(57) ABSTRACT

Provided is a fuel cell system, which can inform the user of the input of a control command for low-temperature countermeasures, if necessary, at a proper timing. A control unit decides whether or not an ambient temperature To of a remote-part temperature is lower than 0° C. for the time period from a start request to a stop request of the system. The control unit informs, when it decides that either temperature is lower than 0° C., the user of a message for urging the input of the control command for the low-temperature countermeasures.

### TECHNICAL FIELD

The present invention relates to a fuel cell system.

### BACKGROUND ART

In a case where an external temperature is low, there occurs a problem that after the stop of a fuel cell system, water generated in the system freezes to damage pipes, valves or the like or a problem that when the frozen water blocks a gas passage and a fuel cell is started next time, the supply of a gas is disturbed and an electrochemical reaction does not sufficiently proceed.

In view of such a problem, a method is suggested in which at a predetermined timing after the stopping of the fuel cell system has been requested (a command for turning off an ignition key or the like), temperature information such as an ambient temperature is acquired, and the freezing of the water is predicted from the temperature information to inform a user of the same (e.g., see Patent Document 1).

According to such a method, the user judges, based on the prediction result displayed in a display or the like (e.g., “there is a possibility of the freezing”), whether or not control (warm-up processing or the like) for low-temperature countermeasures is required, and the user presses a low-temperature countermeasure performing button or the like in accordance with the judgment result. Therefore, the control for the low-temperature countermeasures is performed only at a time when the user judges that the control is necessary. According to such a constitution, the control for the low-temperature countermeasures is not unnecessarily performed, so that the unnecessary consumption of a fuel (hydrogen or the like) can be prevented.

[Patent Document 1] Japanese Patent Application Laid-Open No. 2005-108832

### DISCLOSURE OF THE INVENTION

However, in a case where a message for urging the control for low-temperature countermeasures is informed after the stopping of a fuel cell system has been requested, a user might miss such a message. When the message is missed, a problem occurs that the control for the low-temperature countermeasures is not performed regardless of user's intention.

The present invention has been developed in view of the above situation, and an object thereof is to provide a fuel cell system which can inform the user of the input of a control command for low-temperature countermeasures, if necessary, at a proper timing.

To solve the above-mentioned problem, a fuel cell system according to the present invention is a fuel cell system in which control for low-temperature countermeasures is performed at a time when a request for the low-temperature countermeasures is input from a user, characterized by comprising: judgment means for judging whether or not the system satisfies set conditions for the time period from the input of a start command to the input of a stop command of the system; and informing means for urging the user to input the request for the low-temperature countermeasures during system start in a case where it is judged that the set conditions are satisfied.

According to such a constitution, in a case where the system satisfies the set conditions (temperature conditions of the system and the like), the input of the control command for the low-temperature countermeasures is informed during the system start. Therefore, it is possible to suppress a problem that the user might miss a message.

Here, in the above constitution, the judgment means preferably repeatedly executes the judgment at predetermined time intervals. According to such a constitution, the judgment can be performed in accordance with the use situation of the system or the like.

Moreover, it is preferable that the temperature conditions of the system are temperature conditions concerning at least one of the ambient temperature of the system and the part temperature of the system.

Furthermore, the fuel cell system according to the present invention is a fuel cell system in which control for low-temperature countermeasures is performed, characterized by comprising: first judgment means for judging whether or not a temperature concerning the system satisfies first set conditions for the time period from the input of a start command to the input of a stop command of the system; second judgment means for judging whether or not the change of the temperature concerning the system with an elapse of time satisfies second set conditions in a case where it is judged that the first set conditions are satisfied; and control means for performing the control for the low-temperature countermeasures in a case where it is judged that the second set conditions are satisfied.

According to such a constitution, when the control for the low-temperature countermeasures (sweep processing at the end of the system or the like) is performed, the user can securely be informed with, for example, a character message, a voice message or the like, and the user does not have any uncomfortable feeling or false recognition.

Here, the above constitution is characterized in that the temperature concerning the system is an ambient temperature, the first judgment means judges whether or not the ambient temperature is lower than a set reference temperature, and the second judgment means judges whether or not the change of the ambient temperature with an elapse of time is a set difference threshold value or more in a case where the ambient temperature is lower than the set reference temperature.

As described above, according to the present invention, the user can be informed of a message for urging the input of a control command for low-temperature countermeasures, if necessary, at a proper timing.

### BRIEF DESCRIPTION OF THE DRAWINGS

FIG. 1 is a diagram showing the constitution of a fuel cell system according to a first embodiment;

FIG. 2 is a flow chart showing the operation of the fuel cell system according to the embodiment;

FIG. 3 is a graph showing a relation between an ambient temperature and a remote-part temperature according to the embodiment;

FIG. 4 is a diagram illustrating a display screen according to the embodiment;

FIG. 5 is a flow chart showing the operation of a fuel cell system according to a second embodiment;

FIG. 6 is a flow chart showing the operation of a fuel cell system according to a third embodiment; and

FIG. 7 is a diagram showing a change of an ambient temperature with an elapse of time according to the embodiment.

### BEST MODE FOR CARRYING OUT THE INVENTION

Embodiments of the present invention will hereinafter be described with reference to the drawings.

### A. First Embodiment

### (1) Constitution of Embodiment

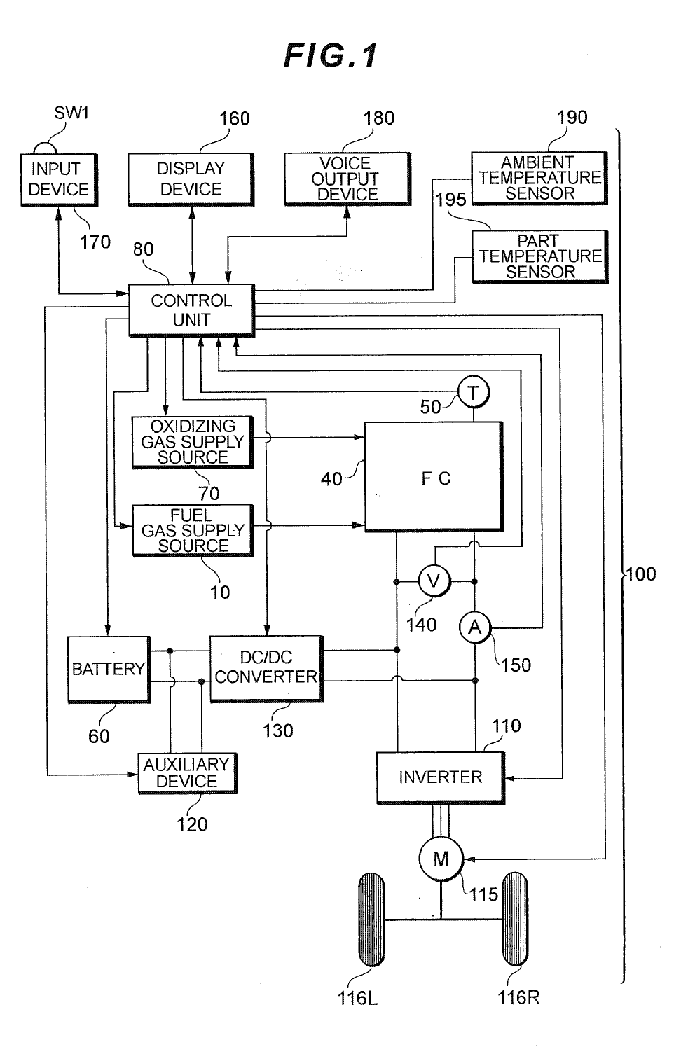

FIG. 1 is a diagram showing the main constitution of a fuel cell system 100 according to a first embodiment. In the present embodiment, a fuel cell system to be mounted on a vehicle such as a fuel cell hybrid vehicle (FCHV), an electric car or a hybrid car is assumed. However, the present invention may be applied not only to the vehicle but also to any type of mobile body (e.g., a ship, an airplane, a robot or the like), a stational power source or the like.

A fuel cell 40 is means for generating power from a supplied reactant gas (a fuel gas or an oxidizing gas), and various fuel cells such as a solid polymer type, a phosphoric type and a molten carbon salt type may be used. The fuel cell 40 has a stack structure in which a plurality of unitary cells including an MEA and the like are laminated in series. The output voltage (hereinafter referred to as the FC voltage) and the output current (hereinafter referred to as the FC current) of this fuel cell 40 are detected a voltage sensor 140 and a current sensor 150, respectively. A fuel gas such as a hydrogen gas is supplied from a fuel gas supply source 10 to a fuel pole (an anode) of the fuel cell 40, whereas an oxidizing gas such as air is supplied from an oxidizing gas supply source 70 to an oxygen pole (a cathode).

The fuel gas supply source 10 is constituted of, for example, a hydrogen tank, various valves and the like, and a valve open degree, an ON/OFF time or the like is adjusted to control the amount of the fuel gas to be supplied to the fuel cell 40.

The oxidizing gas supply source 70 is comparative exampled of, for example, an air compressor, a motor for driving the air compressor, an inverter and the like, and the rotation number of the motor or the like is adjusted to adjust the amount of the oxidizing gas to be supplied to the fuel cell 40.

A battery 60 is a chargeable/dischargeable secondary cell, and is constituted of, for example, a nickel hydrogen battery or the like. Needless to say, instead of the battery 60, a chargeable/dischargeable accumulate (e.g., a capacitor) other than the secondary cell may be provided. This battery 60 is connected in parallel to the fuel cell 40 via a DC/DC converter 130.

An inverter 110 is, for example, a PWM inverter of a pulse width modulation system, and converts direct-current power output from the fuel cell 40 or the battery 60 into three-phase alternating power in accordance with a control command given from a control unit 80 to supply the power to a traction motor 115. The traction motor 115 is a motor (i.e., a power source of a mobile body) for driving wheels 116L, 116R, and the rotation number of such a motor is controlled by the inverter 110. This traction motor 115 and the inverter 110 are connected to a fuel cell 40 side.

The DC/DC converter 130 is a full bridge converter constituted of, for example, four power transistors and a driving circuit for exclusive use (both are not shown in the drawing). The DC/DC converter 130 includes a function of raising or lowering a DC voltage input from the battery 60 to output the voltage to the fuel cell 40 side, and a function of raising or lowering a DC voltage input from the fuel cell 40 or the like to output the voltage to a battery 60 side. Moreover, the charging/discharging of the battery 60 is realized by the function of the DC/DC converter 130.

Auxiliary devices 120 such as a vehicle auxiliary device and an FC auxiliary device are connected between the battery 60 and the DC/DC converter 130. The battery 60 is a power source for these auxiliary devices 120. It is to be noted that the vehicle auxiliary devices are power apparatuses (an illumination apparatus, an air conditioning apparatus, a hydraulic pump, etc.) for use in driving a vehicle or the like, and the FC auxiliary devices are various power apparatuses (a pump for supplying the fuel gas or the oxidizing gas, etc.) for use in operating the fuel cell 40.

The control unit 80 is constituted of a CPU, an ROM, an RAM and the like, and centrally controls system sections based on sensor signals input from the voltage sensor 140, the current sensor 150, a temperature sensor 50 which detects the temperature of the fuel cell 40, an SOC sensor which detects the charged state of the battery 60, an accelerator pedal sensor which detects the open degree of an accelerator pedal and the like. Moreover, the control unit 80 according to the present embodiment performs control for low-temperature countermeasures, if necessary, not only after the stopping of the fuel cell system has been requested but also for the time period from a start request (a start command) of the fuel cell system to a stop request (a stop command) of the fuel cell system (details will be described later).

A display device (informing means) 160 is constituted of a liquid crystal display, various lamps or the like, and a voice output device (informing means) 180 is constituted of a speaker, an amplifier, a filter or the like. The control unit 80 informs various messages by use of the display device 160 and the voice output device 170. The messages to be informed include a message concerning the control for low-temperature countermeasures such as warm-up processing and sweep processing (e.g., display of a message for urging the input of a control command for the low-temperature countermeasures, etc.; details will be described later).

An input device 170 is constituted of a keyboard, a mouse, a touch panel, various operation switches and the like. The operation switches include a special switch (hereinafter referred to as the low-temperature countermeasure switch) SW1 for inputting a control start/control stop command for the low-temperature countermeasures. A user turns on or off this low-temperature countermeasure switch SW1 to instruct the control start/control stop for the low-temperature countermeasures.

An ambient temperature sensor 190 is a sensor for detecting an ambient temperature, and is provided on, for example, the outer periphery of the vehicle. A part temperature sensor 195 is a sensor which detects the temperatures of various parts (various auxiliary devices, etc.) mounted on the vehicle, and is attached to a part as a detection target. In the present embodiment, the part temperature sensor 195 is attached to a part (hereinafter referred to as the remote part) installed in a portion remote from a heat source (a portion in which the flow rate of a gas to be supplied via a heat source such as an exhaust outlet or a fuel cell or the like). Needless to say, the part to which the part temperature sensor 195 is to be attached is arbitrarily decided.

The control unit 80 determines a low temperature based on the ambient temperature detected by the ambient temperature sensor 190 and the temperature (hereinafter referred to as the remote-part temperature) of the remote part detected by the part temperature sensor 195 to judge whether or not to inform the user of a message for urging the input of the control command for the low-temperature countermeasures.

The operation of the present system will hereinafter be described.

### (2) Operation of Embodiment

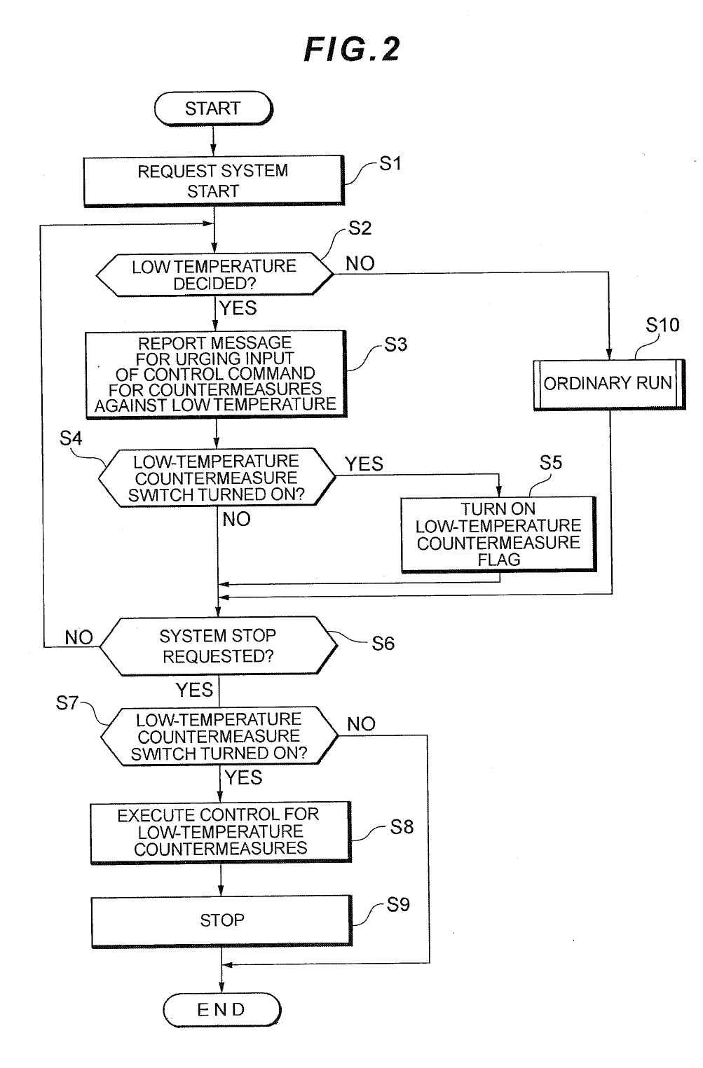

FIG. 2 is a flow chart showing the operation of the fuel cell system 100.

On detecting that the start request (the turning-on of an ignition switch or the like) of the system has been input (Step S1), the control unit 80 decides the low temperature based on an ambient temperature To detected by the ambient temperature sensor 190 and a remote-part temperature Tp detected by the part temperature sensor 195 (Step S2). This will be described in detail. The control unit (judgment means) 80 compares the ambient temperature To or the remote-part temperature Tp with a preset reference temperature Ts (e.g., 0° C.) to judge whether or not the ambient temperature To or the remote-part temperature Tp is lower than the reference temperature Ts.

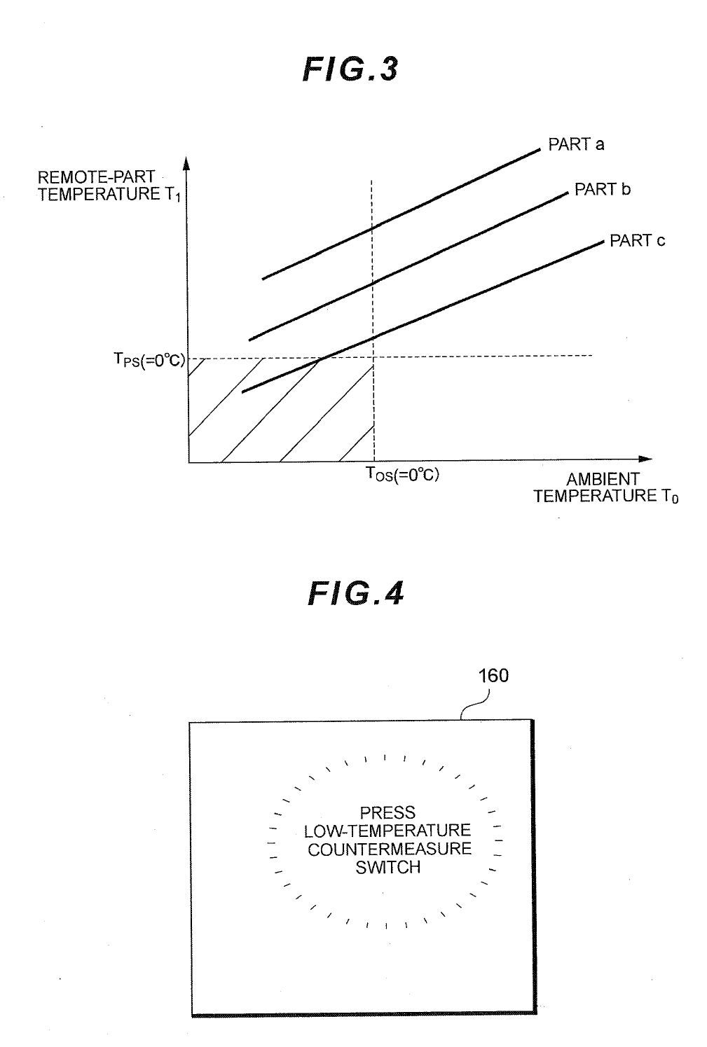

FIG. 3 is a diagram showing a relation between the ambient temperature and the remote-part temperature. The abscissa indicates the ambient temperature, and the ordinate indicates the remote-part temperature. As shown in FIG. 3, in a state in which a reference temperature Tos of the ambient temperature To and a reference temperature Tps of the remote-part temperature T are set to 0° C., respectively, the control unit 80 judges whether or not the ambient temperature To or the remote-part temperature Tp is lower than 0° C. Here, in a case where a plurality of remote parts are disposed, it may be judged whether or not the temperature Tp of the remote part (a part c in FIG. 3) having the lowest temperature is lower than 0° C. However, the remote part whose temperature is to be used is arbitrary.

When the ambient temperature To or the remote-part temperature Tp is 0° C. or more, the control unit 80 judges that the control for the low-temperature countermeasures is unnecessary, and starts ordinary run (Step S2→Step S10). On the other hand, in a case where the control unit (the informing means) 80 judges that the ambient temperature To or the remote-part temperature Tp is lower than 0° C. (see a hatched portion shown in FIG. 3), the message for urging the input of the control command for the low-temperature countermeasures is displayed in the display device 160 as shown in FIG. 4, and the voice message for urging the input of the control command is output from the voice output device 180 (Step S2→Step S3). The user confirms the message displayed in the display device 160 or the like to judge whether or not to execute the control for the low-temperature countermeasures. On judging that the control for the low-temperature countermeasures is necessary, the user turns on the low-temperature countermeasure switch SW1. On detecting that the low-temperature countermeasure switch SW1 has been turned on (Step S4; YES), the control unit 80 turns on a low-temperature countermeasure flag stored in a memory (not shown) (Step S5), and then stops the informing of the message. Afterward, the control unit 80 judges whether or not the stopping of the system (the turning-off of the ignition switch) has been requested (Step S6), and returns to Step S2, when it is judged that the stopping has not been requested. In consequence, a series of processing including the above low-temperature judgment is repeatedly executed.

On the other hand, in a case where it is not detected in Step S4 that the low-temperature countermeasure switch SW1 has been turned on (Step S4; NO), the control unit 80 advances to Step S6 to judge whether or not the stopping of the system has been requested. In a case where it is judged that the stopping has not been requested, the control unit returns to Step S2 in the same manner as described above, thereby executing the above series of processing.

In a case where it is not detected in Step S4 that the low-temperature countermeasure switch SW1 has been turned on (Step S4; NO), the control unit 80 advances to Step S6 to judge whether or not the stopping of the system has been requested. Even after the ordinary run is started, the control unit 80 advances to Step S6 to perform similar processing (Step S10→Step S6).

Afterward, on detecting that the stopping of the system has been requested, the control unit 80 judges whether or not the low-temperature countermeasure switch SW1 is turned on with reference to the low-temperature countermeasure flag. When the low-temperature countermeasure switch SW1 is turned off (Step S7; NO), the following control for the low-temperature countermeasures is not performed, and processing (stop processing) such as the stop of the supply of the gas is performed (Step S9).

On the other hand, when the low-temperature countermeasure switch SW1 is turned on (Step S7; YES), sweep processing or the like is executed as the control for the low-temperature countermeasures (Step S8). Such sweep processing can be executed to decrease a water content accumulated in a pipe or the like, and it is possible to suppress a problem that the water accumulated in the pipe freezes and damages the pipe. When the control for the low-temperature countermeasures ends, the control unit 80 performs the stop processing in the same manner as described above (Step S9), thereby ending the processing.

As described above, according to the present embodiment, it is judged whether or not the ambient temperature To or the remote-part temperature Tp is lower than 0° C. for the time period from the start request to the stop request of the system, and the message for urging the control command for the low-temperature countermeasures is informed in a case where either temperature is lower than 0° C., so that it is possible to suppress a problem that the user misses such a message.

### MODIFICATION

(1) In the above first embodiment, when the ambient temperature To or the remote-part temperature Tp is the reference temperature Ts or more, the message for urging the input of the control command for the low-temperature countermeasures is informed, but such a message may be informed only in a case where both the conditions are satisfied.

(2) Moreover, in the above first embodiment, based on the temperature conditions concerning the system (the temperature conditions of the ambient temperature To or the remote-part temperature Tp), it is judged whether or not to inform the message for urging the input of the control command for the low-temperature countermeasures, but it may be judged whether or not to inform such a message based on other conditions (e.g., the flow rate of a fuel gas or the like).

### B. Second Embodiment

In the above first embodiment, when the ambient temperature To or the remote-part temperature Tp is lower than 0° C., the user is informed and urged to turn on a switch for a low-temperature countermeasure control command, but the user might miss the message. Therefore, the low-temperature countermeasures may be performed even when the switch is not turned on after the informing.

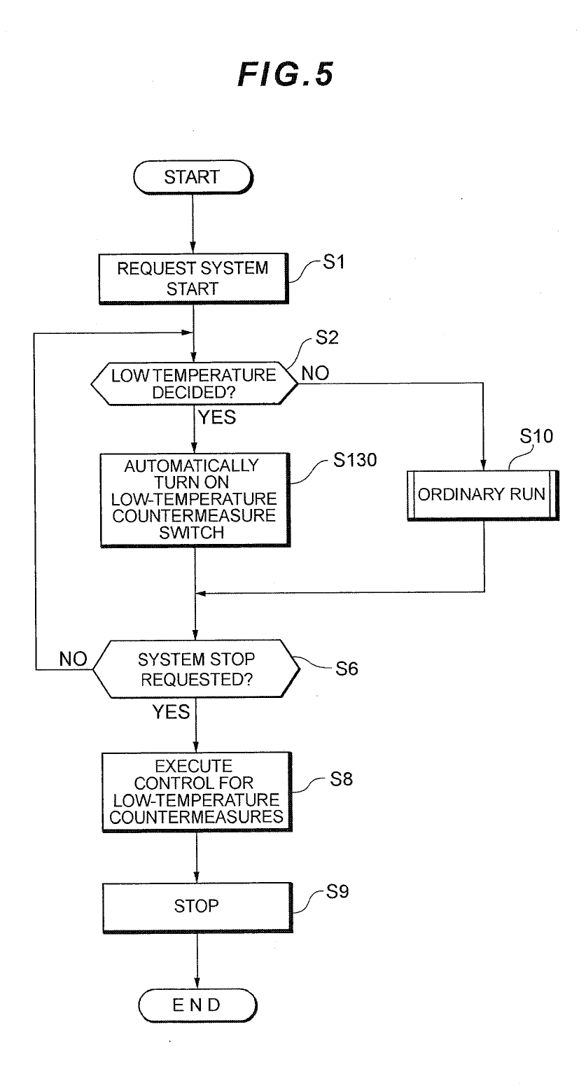

FIG. 5 is a flow chart showing the operation of a fuel cell system 100 according to the second embodiment. It is to be noted that steps corresponding to those of the flow chart shown in FIG. 2 are denoted with the same reference numerals, and detailed description thereof is omitted.

On detecting that the start request (the turning-on of an ignition switch or the like) of the system has been input (Step S1), a control unit 80 decides a low temperature based on an ambient temperature To detected by an ambient temperature sensor 190 and a remote-part temperature Tp detected by a part temperature sensor 195 (Step S2).

When the ambient temperature To or the remote-part temperature Tp is 0° C. or more, the control unit 80 judges that control for low-temperature countermeasures is unnecessary, and starts ordinary run (Step S2→Step S10). On the other hand, in a case where the control unit 80 judges that the ambient temperature To or the remote-part temperature Tp is lower than 0° C., the control unit 80 does not urge the user to judge whether or not to execute the control for the low-temperature countermeasures, and turns on a low-temperature countermeasure switch SW1 (Step S130). When the low-temperature countermeasure switch SW1 is turned on, the control unit 80 advances to Step S6 to judge whether or not the stopping of the system has been requested. In a case where it is judged that the stopping has not been requested (Step S6; NO), the control unit returns to Step S2 to execute the above series of processing in the same manner as described above.

Afterward, on detecting that the stopping of the system has been requested (Step S6; YES), sweep processing or the like is executed as the control for the low-temperature countermeasures. Such sweep processing can be executed to decrease a water content accumulated in a pipe or the like, and it is possible to suppress a problem that water accumulated in the pipe freezes and damages the pipe. When the control for the low-temperature countermeasures ends, the control unit 80 performs the stop processing in the same manner as described above (Step S9), thereby ending the processing.

As described above, according to the present embodiment, it is judged whether or not the ambient temperature To or the remote-part temperature Tp is lower than 0° C. for the time period from the start request to the stop request of the system, and the low-temperature countermeasure switch SW1 is automatically turned on in a case where either temperature is lower than 0° C., so that the control for the low-temperature countermeasures can securely be executed.

It is to be noted that it may be set whether or not the low-temperature countermeasures are required in two stages such as “necessary” and “absolutely necessary”. Then, in a case where it is set that the countermeasures are “necessary”, it is informed to urge that the switch be turned on, but any low-temperature processing is not performed at a time when the switch is turned off. On the other hand, in a case where it is set that the countermeasures are “absolutely necessary”, and the switch remains to be off, it is judged that there is securely a problem due to the low temperature, and the low-temperature countermeasures are automatically executed even when the switch is off. Such control may be performed.

### MODIFICATION

(1) In the above second embodiment, when the ambient temperature To or the remote-part temperature Tp is a reference temperature Ts or more, the low-temperature countermeasure switch SW1 is automatically turned on, but the switch SW1 may be turned on only in a case where both the conditions are satisfied.

### C. Third Embodiment

In the above second embodiment, when the ambient temperature To or the remote-part temperature Tp is lower than 0° C., the control for the low-temperature countermeasures is automatically executed. However, when a running vehicle stops in an indoor parking lot, for example, in winter, a rapid temperature change is sometimes generated. When the vehicle is sufficiently warmed owing to the rapid temperature change, the control for the low-temperature countermeasures is not required. However, even in a case where such a rapid temperature change is generated, when the control for the low-temperature countermeasures is performed, a problem that a fuel gas is uselessly consumed or the like is generated.

The following third embodiment has been developed to solve such a problem, and an object thereof is to provide a fuel cell system capable of preventing that control for low-temperature countermeasures is unnecessarily performed, to suppress a problem that a fuel gas is uselessly consumed or the like.

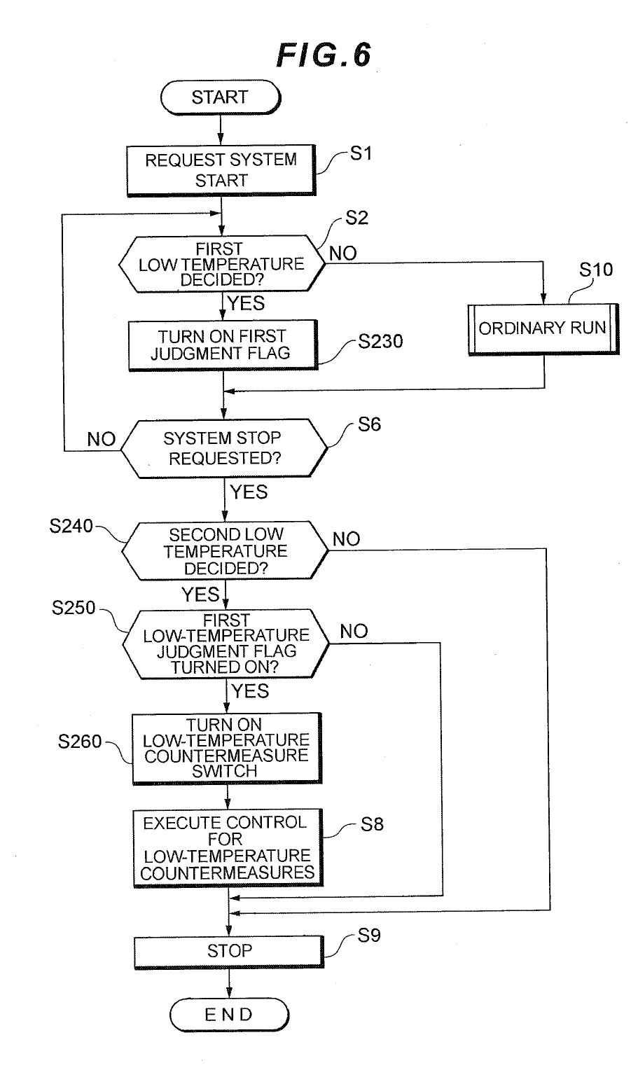

FIG. 6 is a flow chart showing the operation of a fuel cell system 100 according to the third embodiment. It is to be noted that steps corresponding to those of the flow chart shown in FIG. 2 are denoted with the same reference numerals, and detailed description thereof is omitted.

On detecting that the start request (the turning-on of an ignition switch or the like) of the system has been input (Step S1), a control unit 80 (first judgment means) performs first low-temperature judgment based on an ambient temperature To detected by an ambient temperature sensor 190 and a remote-part temperature Tp detected by a part temperature sensor 195 (Step S2). This will be described in detail. The control unit 80 compares the ambient temperature To and the remote-part temperature Tp with a preset first reference temperature Ts1 (e.g., 0° C.) to judge whether or not the ambient temperature To and the remote-part temperature Tp are lower than the first reference temperature (e.g., 0° C.) Ts1. It is to be noted that the detected ambient temperature To is stored in a time series order with respect to a temperature detection memory (not shown).

When the ambient temperature To or the remote-part temperature Tp is 0° C. or more, the control unit 80 judges that the control for the low-temperature countermeasures is unnecessary, and starts ordinary run (Step S2→Step S10). On the other hand, in a case where the control unit 80 judges that the ambient temperature To or the remote-part temperature Tp is lower than 0° C., the control unit turns on a first low-temperature judgment flag stored in a memory (not shown) (Step S2→Step S230), and then advances to Step S6.

On advancing to Step S6, the control unit 80 judges whether or not there has been the stop request of the system. In a case where it is judged that there is not any request (Step S6; NO), the control unit returns to Step S2 in the same manner as described above, thereby executing the above series of processing.

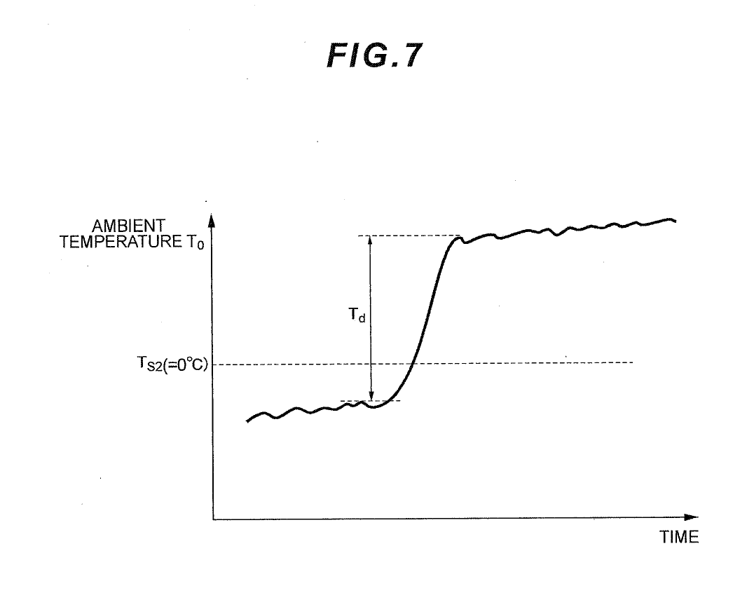

Afterward, on detecting that the stopping of the system has been requested (Step S6; YES), the control unit (second judgment means) 80 performs second low-temperature judgment based on the ambient temperature To detected by the ambient temperature sensor 190 (Step S240). This will be described in detail. The control unit 80 first obtains a differential temperature Td (=Tor−Top; the change of the temperature with an elapse of time) between a presently detected ambient temperature Tor and the previous ambient temperature Top stored in the temperature detection memory, and it judges whether the obtained differential temperature Td is a preset differential threshold value Tt or more or whether the presently detected ambient temperature Tor is a preset second reference temperature Ts2 (e.g., 0° C.) or more (see FIG. 7).

In a case where in the second low-temperature judgment, the control unit 80 judges that the obtained differential temperature Td is the preset differential threshold value Tt or more or that the presently detected ambient temperature Tor is 0° C. or more, the control unit does not perform any control for the low-temperature countermeasures, and stops the system.

On the other hand, when the obtained differential temperature Td is lower than the preset differential threshold value Tt and the presently detected ambient temperature Tor is lower than 0° C., the control unit 80 advances to Step S250 to judge whether or not the first low-temperature judgment flag has been turned on.

When the first low-temperature judgment flag is not turned on, the control unit 80 does not perform any control for the low-temperature countermeasures, and stops the system. On the other hand, when the first low-temperature judgment flag is turned on, the control unit (control means) 80 turns on a low-temperature countermeasure switch SW1 (Step S260), and then executes sweep processing or the like as the control for the low-temperature countermeasures (Step S8). Such sweep processing can be executed to decrease a water content accumulated in a pipe or the like, and it is possible to suppress a problem that the water accumulated in the pipe freezes and damages the pipe. When the control for the low-temperature countermeasures ends, the control unit 80 performs the stop processing in the same manner as described above (Step S9), thereby ending the processing.

As described above, according to the present embodiment, when a rapid temperature change is generated (e.g., a running vehicle stops in an indoor parking lot, for example, in winter), the control for the low-temperature countermeasures is not executed, so that it is possible to prevent a problem that the control for the low-temperature countermeasures is unnecessarily performed to uselessly consume a fuel gas.

### MODIFICATION

(1) In the above third embodiment, the second low-temperature judgment is performed based on the ambient temperature, but instead of this (or additionally), the second low-temperature judgment may be performed based on the remote-part temperature. Specifically, the differential temperature Td (=Tpr−Tpp) between the presently detected remote-part temperature Tpr and the previous remote-part temperature Tpp stored in the temperature detection memory may be obtained to judge whether the obtained differential temperature Td is the preset differential threshold value Tt or more or whether the presently detected remote-part temperature Tpr is the preset second reference temperature Ts2 or more.

(2) Moreover, in the above third embodiment, as the first reference temperature Ts1 and the second reference temperature Ts2, “0° C.” has been illustrated, but another temperature (e.g., 5° C.) may be used, or the reference temperatures Ts1, Ts2 may be different from each other.

(3) Furthermore, in the above third embodiment, when the obtained differential temperature Td is the preset differential threshold value Tt or more or the presently detected ambient temperature Tor is the preset second reference temperature Ts2 or more, the control for the low-temperature countermeasures is performed, but the control for the low-temperature countermeasures may be performed in a case where both the conditions are satisfied.

It is to be noted that, needless to say, the above-mentioned embodiments and modifications may appropriately be combined.

1. A fuel cell system in which control for low-temperature countermeasures is performed at a time when a request for the low-temperature countermeasures is input from a user, comprising:
a judgment device to judge whether or not the system satisfies set conditions for the time period from the input of a start command to the input of a stop command of the system; and
an informing mechanism to urge the user to input the request for the low-temperature countermeasures for the time period from the input of the start command to the input of the stop command of the system in a case where it is judged that the set conditions are satisfied.

2. The fuel cell system according to claim 1, wherein the judgment means repeatedly executes the judgment at predetermined time intervals.

3. The fuel cell system according to claim 1, wherein the set conditions are temperature conditions concerning the system.

4. The fuel cell system according to claim 3, wherein the temperature conditions concerning the system are temperature conditions concerning at least one of the ambient temperature of the system and the part temperature of the system.

5. A fuel cell system in which control for low-temperature countermeasures is performed, comprising:
a first judgment device to judge whether or not a temperature concerning the system satisfies first set conditions for the time period from the input of a start command to the input of a stop command of the system;
a second judgment device to judge whether or not the change of the temperature concerning the system with an elapse of time satisfies second set conditions in a case where it is judged that the first set conditions are satisfied; and
a control device to perform the control for the low-temperature countermeasures in a case where it is judged that the second set conditions are satisfied.

6. (canceled)
